(19) United States
(12) Patent Application Publication
(10) Pub. No.: US 2024/0004041 A1
(43) Pub. Date: Jan. 4, 2024

(54) DISTANCE MEASURING DEVICE AND DISTANCE MEASURING SYSTEM

(71) Applicant: Panasonic Intellectual Property Management Co., Ltd., Osaka (JP)

(72) Inventors: Shota YAMADA, SHIGA (JP); Masato TAKEMOTO, OSAKA (JP); Shigeru SAITOU, KYOTO (JP)

(21) Appl. No.: 18/466,429

(22) Filed: Sep. 13, 2023

Related U.S. Application Data
(63) Continuation of application No. PCT/JP2022/001822, filed on Jan. 19, 2022.

(30) Foreign Application Priority Data
Mar. 31, 2021 (JP) 2021-060606

(51) Int. Cl. G01S 7/484; G01S 17/894; G01S 7/4865

(52) U.S. Cl. CPC G01S 7/484; G01S 17/894; G01S 7/4865

(57) ABSTRACT

A distance measuring device includes: a light source configured to project pulsed light; a light receiver configured to receive reflected light; a distance measurement controller configured to select, for distance measurement, one of distance measurement sections set in accordance with distances, and control operation times of the light source and the light receiver in accordance with the selected one of the distance measurement sections; and a distance image generator configured to generate a section image from a signal output from the light receiver, and combine section images corresponding to the distance measurement sections to generate a distance image. The distance measurement controller includes a random number generator configured to generate random number data for selecting one of the distance measurement sections randomly.

### CROSS-REFERENCE TO RELATED APPLICATIONS

This is a continuation of International Application No. PCT/JP2022/001822 filed on Jan. 19, 2022, which claims priority to Japanese Patent Application No. 2021-060606 filed on Mar. 31, 2021. The entire disclosures of these applications are incorporated by reference herein.

### BACKGROUND

The present disclosure relates to a distance measuring device that generates a distance image from section images of sections divided from a target space to be imaged in accordance with distances.

Active distance measuring devices, such as time-of-flight (ToF) systems are typically known. This distance measuring device projects laser beams repeatedly with a predetermined pulse width and receives reflected light which corresponds to the projected laser beam after hitting and reflected by an object, thereby measuring a distance based on the round-trip time of the laser beams (i.e., a phase difference of the laser beams related to the outward and return trip).

Such a type of distance measuring device may be interfered with by reflected light of a laser beam irradiated from another distance measuring device, and may thus be unable to measure a distance properly when used with other distance measuring devices.

In order to solve this problem, Japanese Unexamined Patent Publication No. 2020-153799 provides a light emission period and a non-light emission period and distance measurement is performed by calculation of subtracting a pixel signal in the non-light emission period from a pixel signal in the light emission period. In addition, the lengths of the light emission period and the non-light emission period are modulated to reduce the influence of interference light from another distance measuring device.

### Summary

The configuration according to Japanese Unexamined Patent Publication No. 2020-153799 requires a long interval of light emission, which lowers the frame rate.

The present disclosure was made in view of the problem. It is an objective of the present disclosure to provide a distance measuring device that reduces the influence of interference light without lowering the frame rate.

A distance measuring device according to an aspect of the present disclosure includes: a light source configured to project pulsed light toward a target space; a light receiver configured to receive light reflected by an object in the target space; a distance measurement controller configured to select, for distance measurement, one of distance measurement sections set for the target space in accordance with distances, and control a time of projection by the light source and a time of light reception by the light receiver in accordance with the one of the distance measurement sections selected; and a distance image generator configured to generate one of section images corresponding to the one of the distance measurement sections selected by the distance measurement controller from a signal output from the light receiver, and combine the section images corresponding to the distance measurement sections to generate a distance image, the distance measurement controller including a random number generator configured to generate random number data for selecting one of the distance measurement sections randomly.

The present disclosure provides a distance measuring device capable of reducing the influence of interference light without lowering the frame rate.

### BRIEF DESCRIPTION OF THE DRAWINGS

FIG. 1 shows a configuration of a distance measuring device according to a first embodiment.

FIG. 2 shows an example imaging scene.

FIG. 3 shows an example operation of a typical ToF camera.

FIG. 4 shows an example operation of a ToF camera according the embodiment.

FIGS. 5A and B show example distance images in which FIG. 5A shows a typical operation and FIG. 5B shows the embodiment.

FIGS. 6A and 6B show example setting of a light emission pulse and a light exposure pulse, in which FIG. 6A shows a typical driving example and FIG. 6B shows the embodiment.

FIGS. 7A and 7B show example setting of a light emission pulse and a light exposure pulse, in which FIG. 7A shows a typical driving example and FIG. 7B shows a variation.

FIG. 8 shows a configuration of a distance measuring device according to a second embodiment.

FIG. 9 shows example processing of determining the presence or absence of influence of interference light.

FIG. 10 shows example correction, if there is influence of the interference light.

FIGS. 11A and 11B show example influence of interference light in the case where a section for distance measurement is selected randomly.

FIG. 12 shows an example configuration of a distance measuring system according to an embodiment.

### DETAILED DESCRIPTION

### Summary

A distance measuring device according to an aspect of the present disclosure includes: a light source configured to project pulsed light toward a target space; a light receiver configured to receive light reflected by an object in the target space; a distance measurement controller configured to select, for distance measurement, one of distance measurement sections set for the target space in accordance with distances, and control a time of projection by the light source and a time of light reception by the light receiver in accordance with the one of the distance measurement sections selected; and a distance image generator configured to generate one of section images corresponding to the one of the distance measurement sections selected by the distance measurement controller from a signal output from the light receiver, and combine the section images corresponding to the distance measurement sections to generate a distance image, the distance measurement controller including a random number generator configured to generate random number data for selecting one of the distance measurement sections randomly.

With this configuration, the distance measurement controller can randomly select, for distance measurement, one of the distance measurement sections set for the target space in accordance with the distances. Accordingly, for example, even if there is a laser beam emitted from another distance measuring device, the influence of its reflected light can be dispersed to the distance measurement sections, which can greatly lower the probability that the reflected light is mixed into a section image of a specific one of the distance measurement sections. In addition, the distance measurement sections for distance measurement are simply selected at random, which causes neither a long interval of light emission nor a long frame period. This configuration can reduce the influence of interference light without lowering the frame rate.

The random number generator may generate the random number data so that all the distance measurement sections are selected once in each of frames.

This configuration allows reliable obtainment of the section images of all the distance measurement sections in one frame period.

The distance measurement controller may be configured to randomly delay the time of projection by the light source and the time of light reception by the light receiver in the one of the distance measurement sections, using random number data generated by the random number generator.

This configuration can further reduce the influence of interference light.

The random delay may be set not to extend a period of time for generating the section image.

This configuration can further reduce the influence of interference light without lowering the frame rate.

The distance image generator may include an interference determiner configured to determine the presence or absence of influence of interference light other than the pulsed light projected from the light source. If the interference determiner determines the presence of influence of interference light, the random number generator may generate the random number data.

This configuration can reduce the influence of interference light, if any, by randomly selecting one of the distance measurement sections for distance measurement.

The interference determiner may determine the presence of influence of interference light upon detection of a signal with a value greater than or equal to a predetermined threshold in a section image as of when the light receiver has received light in a non-emitting state in which the light source projects no pulsed light.

This configuration allows reliable detection of the influence of interference light, if any.

The distance image generator may further include a storage configured to store the section images corresponding to the distance measurement sections for frames. The distance image generator corrects one of the section images influenced by interference light, using the section images of the corresponding distance measurement section in previous and subsequent ones of the frames stored in the storage.

This configuration allows correction of a section image which is influenced by the interference light.

A distance measuring system according to an aspect of the present disclosure includes: two or more distance measuring devices, each being the distance measuring device according to the aspect described above; and a random number assignment controller configured to control an operation of the random number generator included in the distance measurement controller of each of the distance measuring devices.

This configuration can address the problem that random selections of the distance measurement sections by the distance measuring devices fall in the same pattern and that the influence of interference light increases.

The random number assignment controller may give a seed of a pseudo random number to the random number generator and change the seed in time series.

Now, embodiments will be described in detail with reference to the drawings. Unnecessarily detailed description may be omitted. For example, detailed description of already well-known matters or repeated description of substantially the same configurations may be omitted. This is to reduce unnecessary redundancy of the following description and to facilitate the understanding by those skilled in the art.

The accompanying drawings and the following description are provided for sufficient understanding of the present disclosure by those skilled in the art, and are not intended to limit the subject matter of the claims.

### First Embodiment

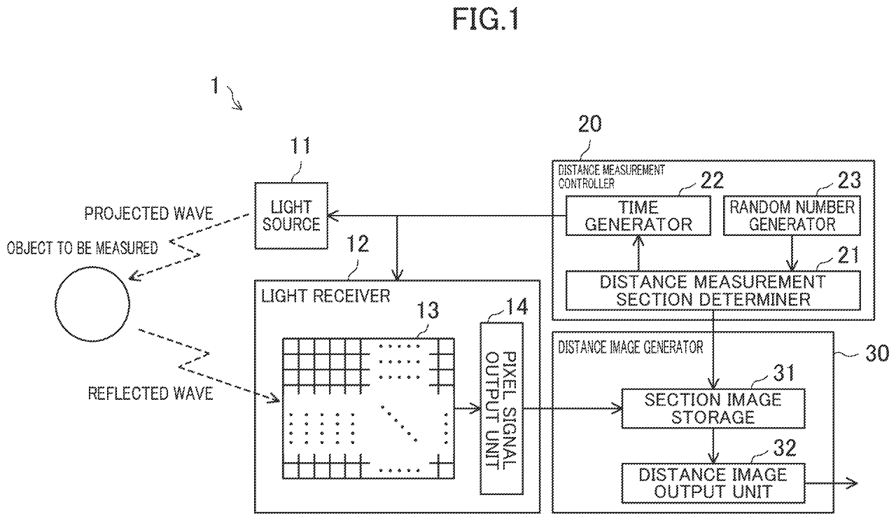

FIG. 1 is a block diagram showing a configuration of a distance measuring device according to a first embodiment. A distance measuring device 1 shown in FIG. 1 includes a light source 11, a light receiver 12, a distance measurement controller 20, and a distance image generator 30. The distance measuring device 1 obtains information on the distance to an object by the time-of-flight (TOF) method and outputs a distance image.

The light source 11 projects pulsed light toward a target space. The light receiver 12 receives the light reflected by an object in the target space. The distance measurement controller controls the pulsed light projection by the light source 11 and the light reception by the light receiver 12. The distance measurement controller 20 sets distance measurement sections (i.e., sub-ranges or also simply referred to as “sections”) for the target space in accordance with the distances. The distance measurement controller 20 then select, for distance measurement, one of the distance measurement sections, and controls the time when the light source 11 projects pulsed light and the time when the light receiver 12 performs light reception (i.e., light exposure), in accordance with the selected distance measurement section. The distance image generator 30 generates one of section images, which corresponds to the distance measurement section selected by the distance measurement controller 20, from a signal output from the light receiver 12. The distance image generator 30 then combines the section images corresponding to the distance measurement sections to generate a distance image indicating distance values.

The light source 11 is a laser diode, for example, and outputs a pulsed laser beam. Besides the laser diode, the light source 11 may be a light emitting diode (LED), a vertical-cavity surface-emitting laser (VCSEL), or a halogen lamp, for example. The pulsed light projected by the light source 11 preferably has a single wavelength, a relatively short pulse width, and a relatively high peak intensity. In addition, the wavelength of the pulsed light falls within a wavelength range of near-infrared which is less visible to human eyes and not easily influenced by ambient light. The light source 11 may include a light projecting optical system, such as a lens, that projects pulsed light to a target space.

The light receiver 12 includes an image sensor 13 with pixels and a pixel signal output unit 14. Avalanche photodiodes are arranged on the pixels of the image sensor 13, for example. Other light detecting elements may be arranged on the pixels. The pixels are switchable between light exposure for receiving reflected light, and non-light exposure for receiving no reflected light. In the light exposure, the light receiver 12 outputs a pixel signal according to the reflected light received by the pixel. The light receiver 12 may include a light receiving optical system, such as a lens, that collects the reflected light on the light receiving surface of the image sensor 13.

When controlling the light emission by the light source 11, the distance measurement controller 20 controls the time when the light source 11 outputs light, the pulse width of the light output from the light source 11, and other factors. When controlling the light reception by the light receiver 12, the distance measurement controller 20 controls the operation times of transistors in the pixels, thereby controlling the light exposure times, the exposure periods, and other factors for the pixels of the image sensor 13. The light exposure times and the exposure periods may be the same among all pixels or may be different from pixel to pixel.

The distance measurement controller 20 includes a distance measurement section determiner 21, a time generator 22, and a random number generator 23. The distance measurement section determiner 21 selects, for distance measurement, one of distance measurement sections set for the target space in accordance with the distances. The time generator 22 controls the time when the light source 11 projects pulsed light and the time when the light receiver 12 performs light reception (i.e., light exposure), in accordance with the selected distance measurement section. The random number generator 23 generates random number data to allow the distance measurement section determiner 21 to select the distance measurement sections randomly.

The distance image generator 30 includes a section image storage 31 and a distance image output unit 32. The section image storage 31 obtains section images indicating reflected light in the distance measurement sections from the pixel signals output from the light receiver 12. The obtained section images for frames are, for example, stored in the section image storage 31. Each frame is the period of the distance measurement in all the distance measurement sections set for the target space. One frame corresponds to one distance image. The distance image output unit 32 combines section images obtained in one frame to generate and output a distance image.

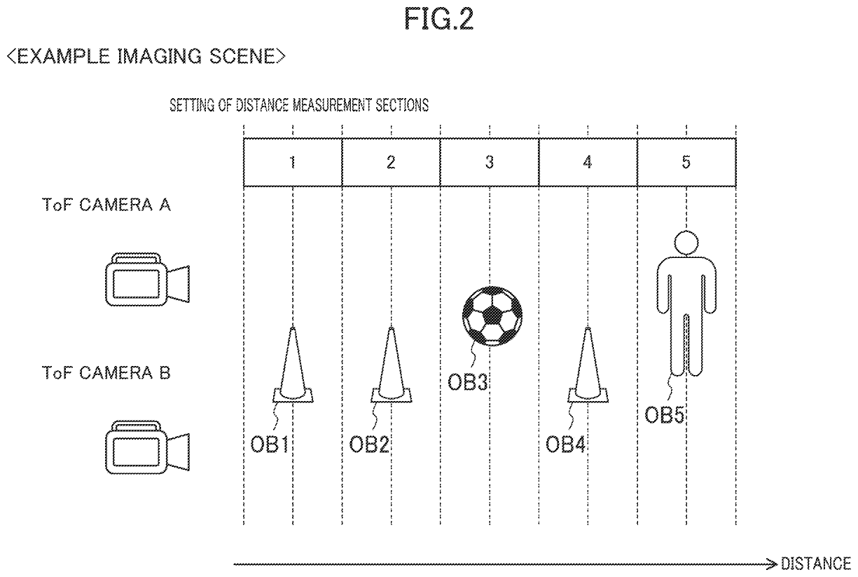

FIG. 2 shows an example imaging scene. In the example of FIG. 2, distance measurement sections 1 to 5 are set in this order from near to far for two ToF cameras (i.e., distance measuring devices) A and B. The distance measurement sections 1 to 5 include a cone OB1, a cone OB2, a soccer ball OB3, a cone OB4, and a person OB5 as objects.

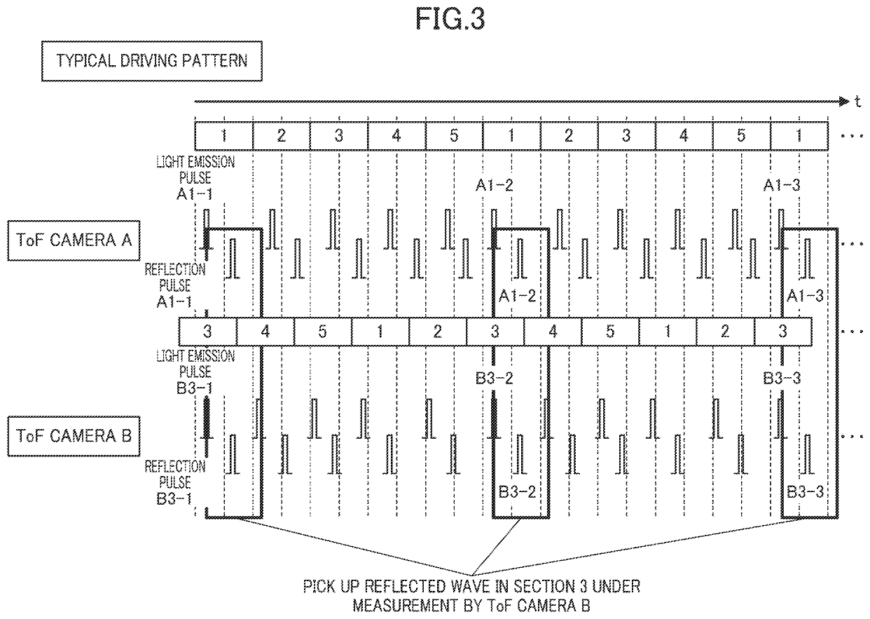

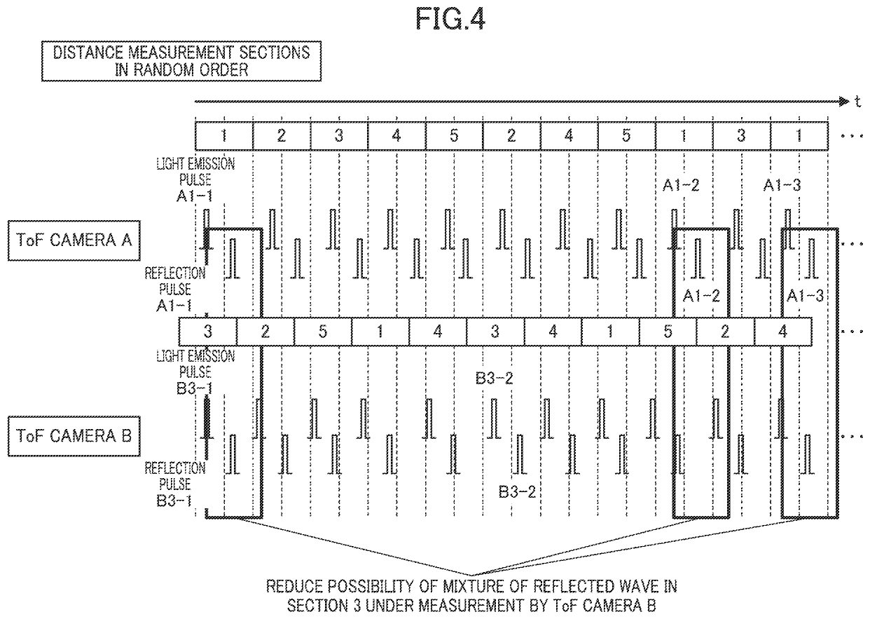

FIG. 3 shows an example operation of a typical ToF camera. FIG. 4 shows an example operation of a ToF camera according the embodiment. In FIGS. 3 and 4, the light emission pulse is for causing the light source 11 to emit light, while the reflection pulse is for causing the light receiver 12 to perform light exposure. The time difference between the light emission pulse and the reflection pulse differs from distance measurement section to distance measurement section, which is however simplified in FIGS. 3 and 4. In addition, the ToF cameras A and B operate asynchronously.

As shown in FIG. 3, in the typical driving pattern, the ToF cameras A and B repeatedly select, for distance measurement, one of the distance measurement sections 1 to 5 in this order. In FIG. 3, the period in which the ToF camera A performs the distance measurement in the distance measurement section 1 overlaps the period in which the ToF camera B performs the distance measurement in the distance measurement section 3. Accordingly, while the ToF camera A performs the distance measurement in the distance measurement section 1, the light receiver 12 may pick up the reflected light in the distance measurement section 3 under the distance measurement by the ToF camera B. That is, the light reflected by the soccer ball OB3 in the distance measurement section 3 in the example imaging scene in FIG. 2 may be mixed into the exposure signal of the distance measurement section 1 under the distance measurement by the ToF camera A. That is, the ToF camera A is influenced by the interference light from the ToF camera B.

On the other hand, as shown in FIG. 4, in this embodiment, ToF cameras A and B select, for distance measurement, one of the distance measurement sections 1 to 5 randomly. Accordingly, the period in which the ToF camera A performs the distance measurement in the distance measurement section 1 less frequently overlaps the period in which the ToF camera B performs the distance measurement in the distance measurement section 3, which greatly lowers the probability that the light receiver 12 picks up the reflected light in the distance measurement section 3 under the distance measurement by the ToF camera B while the ToF camera A performs the distance measurement in the distance measurement section 1. The ToF camera A is thus hardly influenced by the interference light from the ToF camera B.

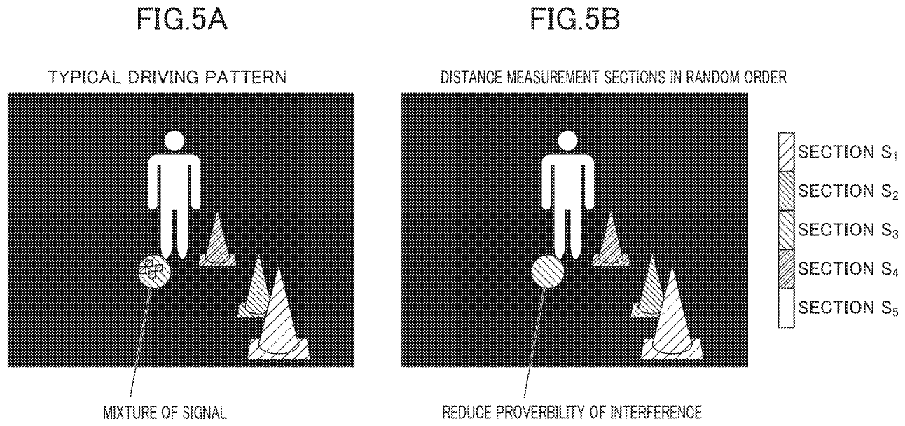

FIGS. 5A and 5B show example distance images output from the ToF camera A, in which FIG. 5A shows a typical operation (see FIG. 3) and FIG. 5B shows the embodiment (see FIG. 4). As shown in FIG. 5A, in the typical driving pattern, the light from ToF camera B is reflected as reflected light by the soccer ball OB3 in the distance measurement section 3, which is mixed into the distance measurement section 1 under the distance measurement. That is, a signal indicating the distance measurement section 1 is mixed. On the other hand, as shown in FIG. 5B, in this embodiment, one of the distance measurement sections is selected for distance measurement randomly, which largely lowers the probability of the mixture of the reflected light of the light from the ToF camera B, thereby causing no mixture of signal.

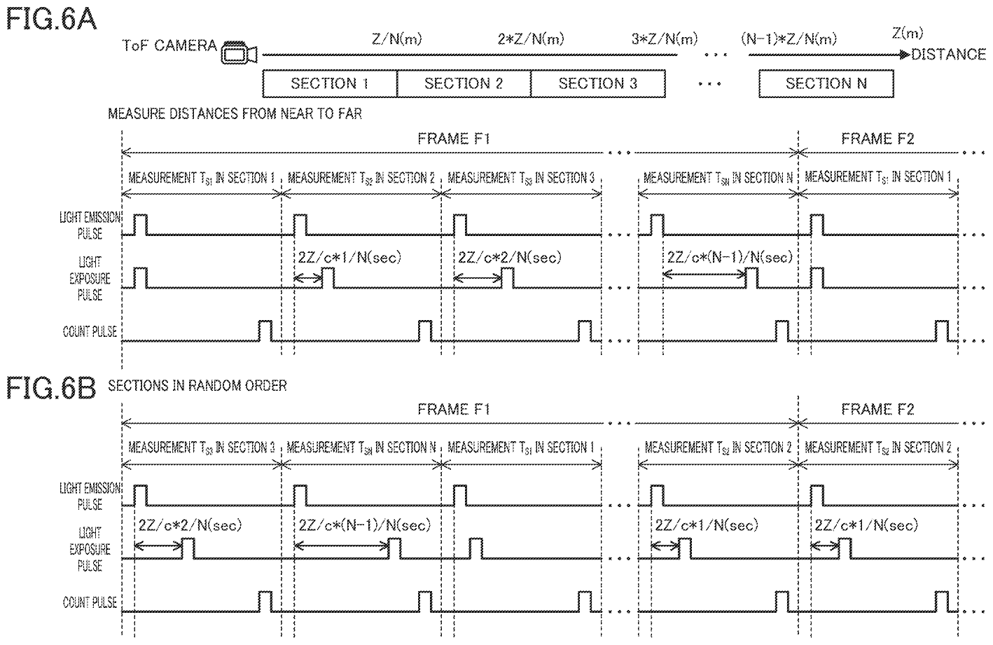

FIGS. 6A and 6B show example setting of a light emission pulse and a light exposure pulse. In FIGS. 6A and 6B, the measurement range with distances from zero to Z (m) is divided into N distance measurement sections 1 to N, where N is an integer of two or more. That is, the distance measurement range of the distance measurement section N is (N−1)/N×Z (m) to Z (m). For each of the distance measurement sections 1 to N, the time difference between the light emission pulse and the light exposure pulse is set in accordance with its distance. That is, the nearest distance measurement section 1 has the smallest time difference between the light emission pulse and the light exposure pulse. With an increasing distance of the distance measurement section, the time difference between the light emission pulse and the light exposure pulse gradually increases. The following equation holds, where T_{dN} is the time difference in this distance measurement section N.

$${T}_{dN} = \frac{N - 1}{N} \times \frac{2 Z}{c} \qquad [ Math 1 ]$$

Note that c is the speed of light.

While being generated once in one measurement period in FIGS. 6A and 6B, the light emission pulse and the light exposure pulse may be generated a plurality of times.

FIG. 6A shows a typical driving example repeating distance measurement in the distance measurement sections in the order from near to far. For example, in a frame F1, the distance measurement section 1 is measured (Tₛ₁) first followed by the distance measurement section 2 (Tₛ₂), the distance measurement section 3 (Tₛ₃), . . . , and the distance measurement section N is measured (T_{sN}) last. Accordingly, the time difference T_{dN} between the light emission pulse and the light exposure pulse increases gradually.

FIG. 6B shows this embodiment selecting the distance measurement sections randomly. For example, in the frame F1, the distance measurement section 3 is measured (Tₛ₃) first, followed by the distance measurement section N (T_{sN}), the distance measurement section 1 (Tₛ₁), . . . , and the distance measurement section 2 is measured (Tₛ₂) last. Accordingly, the time difference between the light emission pulse and the light exposure pulse changes randomly. In addition, in the frame F1, the random selection is performed so that all the distance measurement sections 1 to N are selected once.

As can be seen from FIGS. 6A and 6B, this embodiment causes neither a longer frame period nor a lower frame rate than the typical example.

As described above, according to this embodiment, the distance measurement controller 20 can randomly select, for distance measurement, one of the distance measurement sections set for the target space in accordance with the distances. Accordingly, for example, even if there is a laser beam emitted from another distance measuring device, the influence of its reflected light can be dispersed to the distance measurement sections, which can greatly lower the probability that the reflected light is mixed into a section image of a specific one of the distance measurement sections. In addition, the distance measurement sections for distance measurement are simply selected at random, which causes neither a long interval of light emission nor a long frame period. This configuration can reduce the influence of interference light without lowering the frame rate.

(Variation)

In order to reduce the influence of interference light, the start time of the light emission pulse may be delayed randomly. For this operation, the random number data generated by the random number generator 23 may be used.

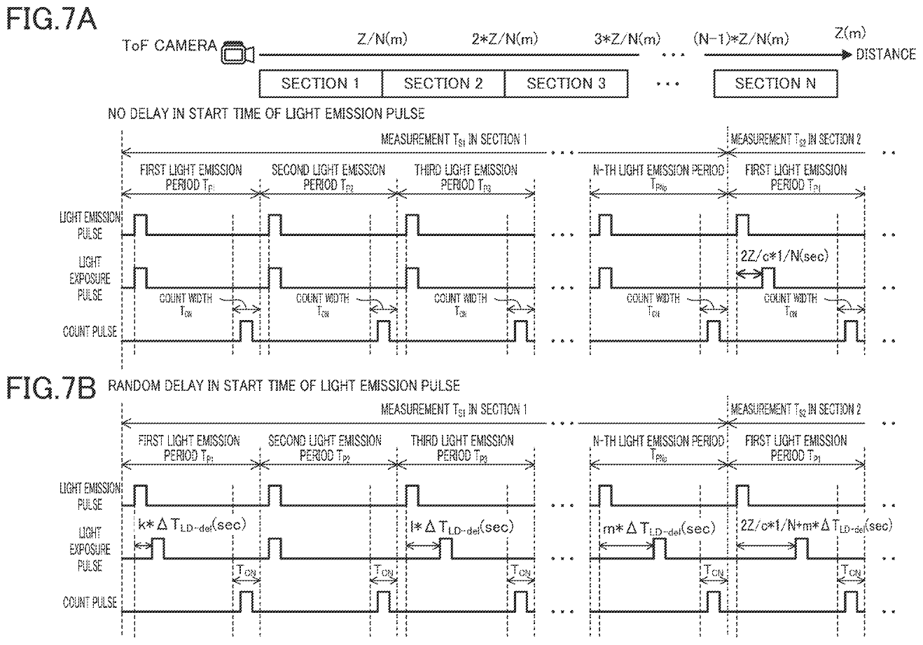

FIGS. 7A and 7B show example settings of a light emission pulse and a light exposure pulse. FIG. 7A shows a typical driving example without any delay in the start time of the light emission pulse. FIG. 7B shows this variation with a random delay in the start time of the light emission pulse. Here, the effect of reducing the influence of interference light is proportional to 1/N_{LD-ran}, where N_{LD-ran} is the number of patterns of the random delay in the start time of the light emission. k, 1, and m are zero or positive integers equal to or smaller than the number N_{LD-ran} of patterns of the random delay in the start time of the light emission.

The sub-range period T_{sN} is as follows.

T_{sN}=Tₚ×Nₚ [Math 2]

TP is the average pulse period, while NP is the number of pulses.

Here, the maximum amount T_{LD-ran} of the delay in the light emission allowable in one distance measurement section is as follows.

$${T}_{LD - ran} = {\underline{{T}_{p} - ( {τ}_{a N} + {T}_{E S} + {T}_{C N} )}}_{CONSTRAINT} > 0 \qquad [ Math 3 ]$$

TES is a light exposure width, and T_{CN} is a count width. In order to maintain the frame rate, the maximum amount T_{LD-ran} of the delay in the light emission needs to be positive. Note that the light exposure width T E s can also be expressed as follows.

$${T}_{E S} = \frac{1}{N} \times \frac{2 Z}{c} \qquad [ Math 4 ]$$

The allowable number N_{LD-ran} of the patterns of the random delay in the start time of the light emission is expressed by the following equation, where ΔT_{LD-ran} is a random delay step width of the start time of light emission.

$${N}_{LD - ran} = \underline{1} + {T}_{L D - r a n} / Δ {T}_{LD - del} \qquad [ Math 5 ]$$

$$DELAY 0 ns$$

In the equation described above, “1” means that the patterns include even the case where there is no delay.

The equation described above can be modified as follows, using Maths 1 to 4.

$$\begin{matrix}{N}_{L D - r a n} = 1 + {T}_{L D - r a n} / Δ {T}_{LD - del} \\ = 1 + \{ {T}_{p} - ( {T}_{dN} + {T}_{E S} + {T}_{C N} ) \} / Δ {T}_{LD - del} \\ = 1 + ( \frac{{T}_{s N}}{{N}_{p}} - \frac{2 Z}{c} - {T}_{C N} ) / Δ {T}_{LD - del}\end{matrix} \qquad [ Math 6 ]$$

Specifically, in this variation, the distance measurement controller 20 is configured to randomly delay the time of projection by the light source 11 and the time of light reception by the light receiver 12 in the one of the distance measurement sections, using the random number data generated by the random number generator 23. This configuration can further reduce the influence of interference light. The random delay is set not to extend a period for generating the section image. This configuration can further reduce the influence of interference light without lowering the frame rate.

### Second Embodiment

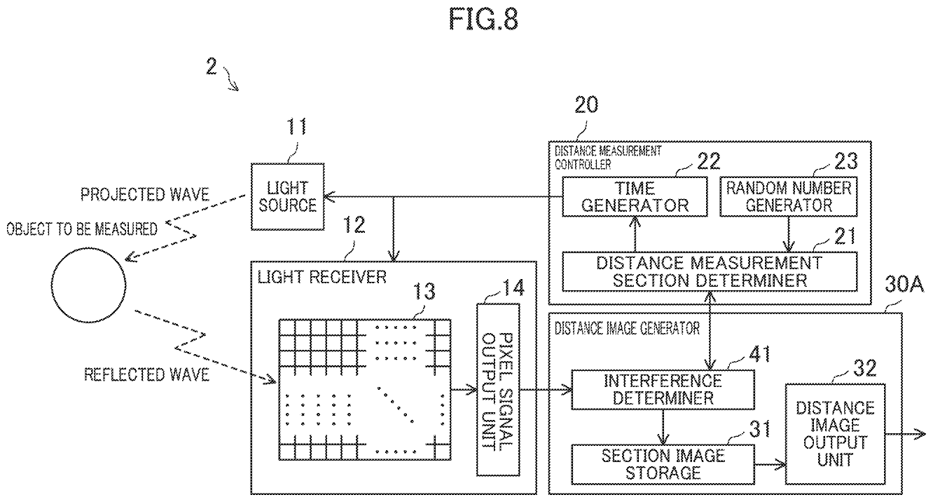

FIG. 8 is a block diagram showing a configuration of a distance measuring device according to a second embodiment. A distance measuring device 2 shown in FIG. 8 has substantially the same configuration as the distance measuring device 1 shown in FIG. 1. However, a distance image generator 30A includes an interference determiner 41. The interference determiner 41 determines the presence or absence of influence of interference light other than the pulsed light projected from the light source 11. If the interference determiner 41 determines the presence of influence of interference light, the distance measurement controller performs random selection.

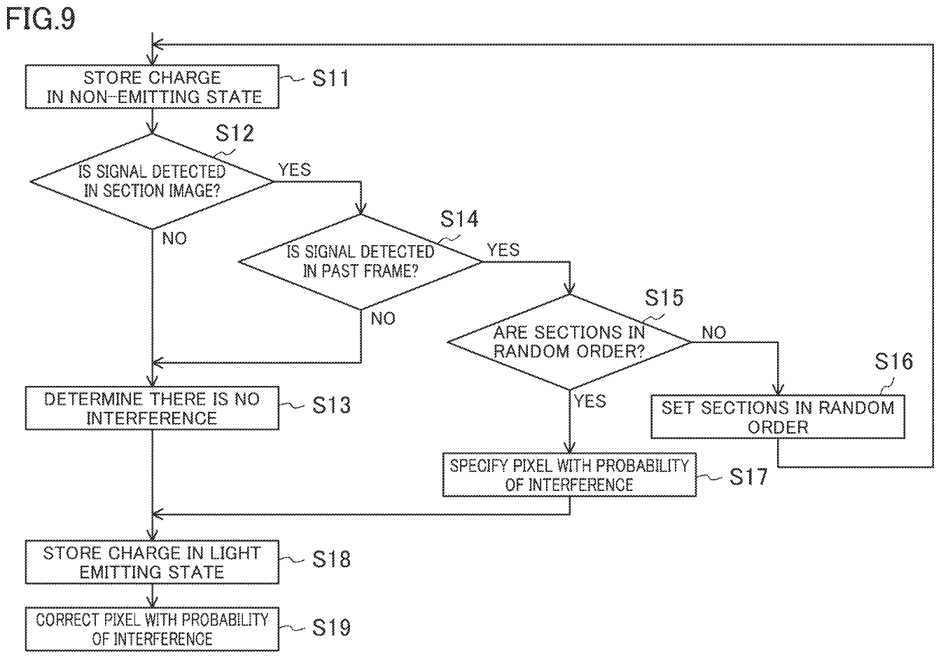

FIG. 9 shows example processing of determining the presence or absence of influence of interference light. First, the distance measurement controller 20 causes the light receiver 12 to receive light in a non-emitting state in which the light sources 11 emits no light (S11). The interference determiner 41 obtains a section image from an output from the light receiver 12 and detects the presence or absence of a signal with a value equal to or greater than a predetermined threshold in this section image (S12). The predetermined threshold may be set based on the signal value of a background image. If there is no signal with a value equal to or greater than the predetermined threshold in the section image in the non-emitting state, the interference determiner 41 determines that there is no interference (S13). On the other hand, if there is a signal with a value equal to or greater than the predetermined threshold in the section image in the non-emitting state, the interference determiner 41 determines whether or not a similar signal has been detected in the past frame (S14). If there is no similar signal, the interference determiner 41 determines that there is no interference.

If a similar signal is detected in a past frame, the interference determiner 41 determines that there is influence of interference light. The interference determiner 41 then determines whether or not the distance measurement sections have already been selected in a random order as shown in the first embodiment (S15). If not selected randomly, the distance measurement sections start being selected randomly (S16), and the process returns to S11. On the other hand, if the distance measurement sections are already selected randomly, a pixel with the possibility of interference is specified from the section image (S17).

After that, the distance measurement controller 20 causes the light receiver 12 to receive light in a light emitting state in which the light sources 11 emits light (S18). Accordingly, the section images of the distance measurement sections can be obtained. With the pixel possibility of interference is specified, the interference determiner 41 corrects the pixel in the section image (S19).

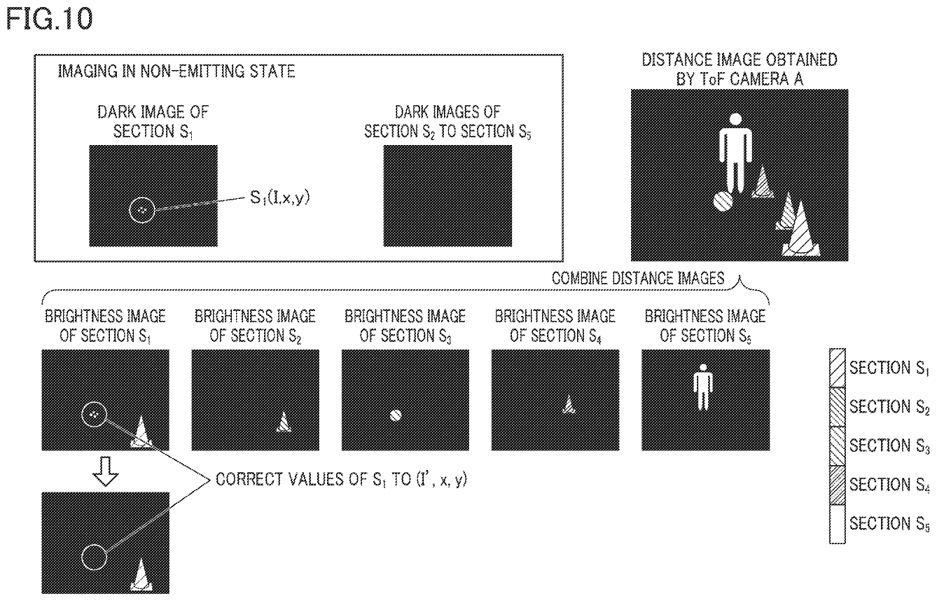

FIG. 10 shows example correction, if there is influence of the interference light. Now, assume that an image is captured in the non-emitting state and, as a result, a signal S₁ with values (I, x, y) over thresholds is detected in a dark image (i.e., the image captured in the non-emitting state) of the distance measurement section S₁. Here, I is a luminance value of a pixel, and x and y are coordinates of the pixel. Assume that a signal with values over the thresholds is detected in none of the dark images of the distance measurement sections S₂ to S₅.

Assume that, imaging is then performed in the light emitting state and the section images of the distance measurement sections S₁ to S₅ are obtained. At this time, in the section image of the distance measurement section S₁, the values (I, x, y) of the signal S₁ are corrected to the values (I′, x, y). Here, the brightness value I′ may be equal to those in the previous and subsequent frames in a non-interference state or that of a background image.

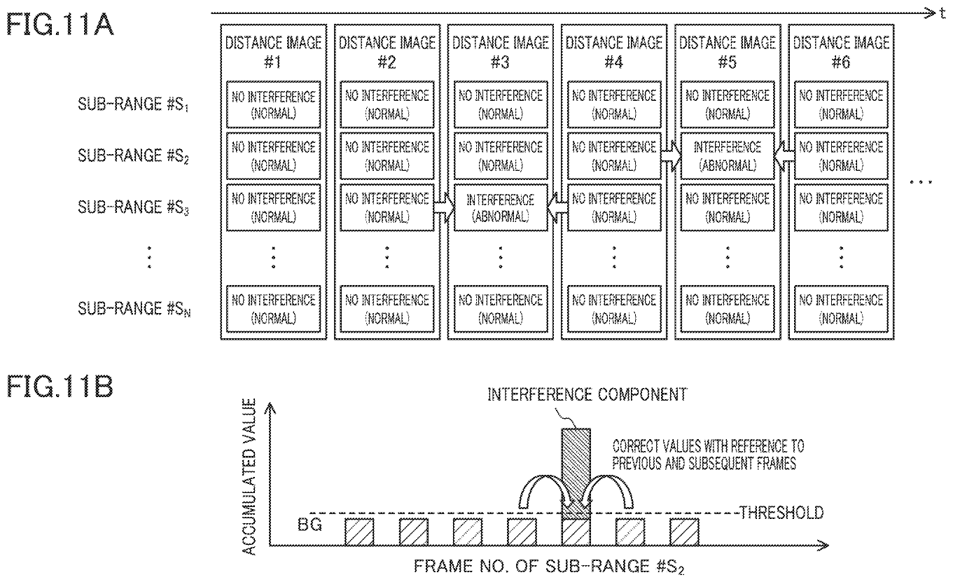

FIGS. 11A and 11B show example influence of interference light where distance measurement sections are selected randomly. As shown in FIGS. 11A and 11B, when the distance measurement sections are selected randomly, the section images are less likely to be abnormal due to interference light and normal section images can be obtained in most cases. The abnormal section images due to interference light can be corrected using the section images of the same distance measurement section in the preceding and following frames.

As described above, according to this embodiment, the distance image generator 30A includes the interference determiner 41 configured to determine the presence or absence of influence of interference light other than the pulsed light projected from the light source 11. If the interference determiner 41 determines the presence of influence of interference light, the distance measurement controller 20 performs random selection. This configuration can reduce the influence of interference light, if any, by randomly selecting one of the distance measurement sections for distance measurement.

While the random sub-ranges are shown in this example, the start time of the light emission may be random as a variation of the first embodiment.

### Example Configuration of Distance Measuring System

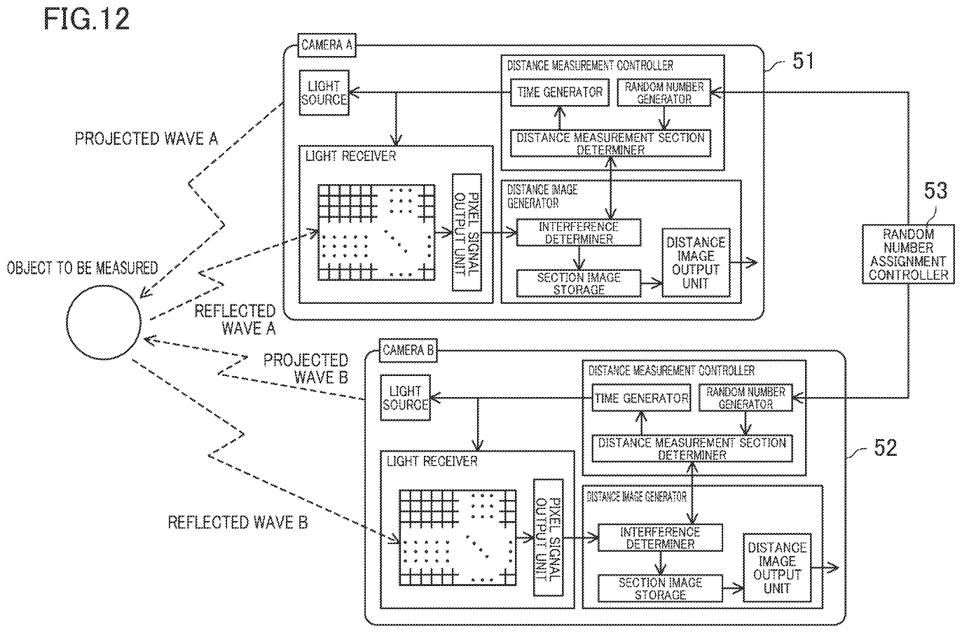

A distance measuring system may be formed by two or more distance measuring devices each being the distance measuring device according to the above embodiments described above. FIG. 12 shows an example configuration of a distance measuring system according to an embodiment. The distance measuring system in FIG. 12 includes two distance measuring devices 51 and 52. The distance measuring devices 51 and 52 have the same configuration as in FIG. 8. The distance measuring system in FIG. 12 includes a random number assignment controller 53 configured to control the operation of the respective random number generators 23 of the distance measuring devices 51 and 52. This configuration can address the problem that random selections of the distance measurement sections by the distance measuring devices 51 and 52 fall in the same pattern and that the influence of interference light increases.

For example, the random number generator 23 includes a linear feedback shift register to generate pseudo random number data. In this case, the random number assignment controller 53 gives a seed of a pseudo random number to the random number generator 23. The random number assignment controller 53 may change the seed of the pseudo random number in time series.

The distance measuring device according to the present disclosure can reduce the influence of interference light without lowering the frame rate, and is thus useful for improving the performance and operation speed of a ToF camera. For example, the distance measuring device is applicable for a monitoring camera system that detects and tracks an object (or a person), a system that is mounted on an automobile and detects an obstacle, and any other suitable system.

What is claimed is:

1. A distance measuring device comprising:
a light source configured to project pulsed light toward a target space;
a light receiver configured to receive light reflected by an object in the target space;
a distance measurement controller configured to select, for distance measurement, one of distance measurement sections set for the target space in accordance with distances, and control a time of projection by the light source and a time of light reception by the light receiver in accordance with the one of the distance measurement sections selected; and
a distance image generator configured to generate one of section images corresponding to the one of the distance measurement sections selected by the distance measurement controller from a signal output from the light receiver, and combine the section images corresponding to the distance measurement sections to generate a distance image,
the distance measurement controller including a random number generator configured to generate random number data for selecting one of the distance measurement sections randomly.

2. The distance measuring device of claim 1, wherein
the random number generator generates the random number data so that all the distance measurement sections are selected once in each of frames.

3. The distance measuring device of claim 1, wherein
the distance measurement controller is configured to randomly delay the time of projection by the light source and the time of light reception by the light receiver in the one of the distance measurement sections, using random number data generated by the random number generator.

4. The distance measuring device of claim 3, wherein
the random delay is set not to extend a period of time for generating the section image.

5. The distance measuring device of claim 1, wherein
the distance image generator includes:
an interference determiner configured to determine presence or absence of influence of interference light other than the pulsed light projected from the light source, and
if the interference determiner determines the presence of influence of interference light, the random number generator generates the random number data.

6. The distance measuring device of claim 5, wherein
the interference determiner determines the presence of influence of interference light upon detection of a signal with a value greater than or equal to a predetermined threshold in a section image as of when the light receiver has received light in a non-emitting state in which the light source projects no pulsed light.

7. The distance measuring device of claim 6, wherein
the distance image generator further includes a storage configured to store the section images corresponding to the distance measurement sections for frames, and
the distance image generator corrects one of the section images influenced by interference light, using the section images of the corresponding distance measurement section in previous and subsequent ones of the frames stored in the storage.

8. A distance measuring system comprising:
two or more distance measuring devices, each being the distance measuring device of claim 1; and
a random number assignment controller configured to control an operation of the random number generator included in the distance measurement controller of each of the distance measuring devices.

9. The distance measuring system of claim 8, wherein
the random number assignment controller gives a seed of a pseudo random number to the random number generator and changes the seed in time series.
